(19) United States
(12) Patent Application Publication
(10) Pub. No.: US 2016/0370125 A1
(43) Pub. Date: Dec. 22, 2016

(54) DEVICE FOR DRIVING AT LEAST ONE SUBASSEMBLY CAPABLE OF TRANSFORMING ELECTRICAL ENERGY AND OF STORING SAID ENERGY IN THERMAL FORM, ASSOCIATED SYSTEM AND METHOD

(71) Applicant: Jerome GILBERT, Levallois Perret (FR)

(72) Inventor: Jerome GILBERT, Levallois Perret (FR)

(21) Appl. No.: 15/122,371

(22) PCT Filed: Feb. 9, 2015
(86) PCT No.: PCT/IB2015/050973

§ 371 Date: Aug. 29, 2016

(30) Foreign Application Priority Data
Feb. 27, 2014 (FR) FR1400496

(51) Int. Cl. F28D 20/02; H02J 3/28; F28D 20/00

(52) U.S. Cl. CPC F28D 20/028; F28D 20/0034; H02J 3/28

(57) ABSTRACT

A device for driving at least one subassembly capable of transforming electrical energy and of storing the energy in thermal form. The device is distinguished by its capacity to receive a setpoint in order to provide a predetermined quantity of electrical energy originating from an electrical installation to at least one subassembly capable of transforming electrical energy and of storing it in thermal form. The system includes a device and at least one subassembly capable of transforming electrical energy and of storing it in thermal form. A method of utilizing a plurality of systems within an electrical network as well as the applications of this method for the management of an electrical network including intermittently producing energy sources. The method is particularly intended for managing an electrical energy distribution network including energy sources for the intermittent production, energy storage, provision of hot water for sanitation purposes, heating, cooling and/or electricity.

### TECHNICAL FIELD

The invention falls within the scope of electrical network management.

### BACKGROUND OF THE INVENTION

Modern electrical networks are becoming increasingly complex as shown in patent FR2976415. They include an increasing proportion of variable production and distribution infrastructures close to saturation in front of constantly growing needs. The proportion of intermittent production of solar or wind origin for example is continuously growing in the energy mix of most countries engaged in a process of energy transition towards more renewable energy. However, the increase in the proportion provided by renewal energy sources for intermittent production in the energy mix beyond 30% requires the implementation of solutions for storing energy produced at times when it exceeds demand to restore it at times when it is deficient. Of the storage solutions considered, disseminated storage in thermal form is particularly advantageous especially as transformation and transportation losses are incurred only once. In this category of energy storage means, the installed base of storage apparatuses for hot water for sanitation purposes represents a significant storage capacity in most countries. For example in France there are about 14.5 million water heaters in service representing a storage capacity of more than 20 million MWh of electricity or about 50% of the annual hydroelectric production of the country. This type of apparatus is traditionally driven by controlling their On and Off status according to electricity tariff conditions. The most well-known case is the control of the operation of an electric water-heater according to off-peak rates/peak rates. Thus, the implemented technical solutions for driving these apparatuses in terminal electrical installations are embedded with tariff management solutions as shown in patent FR2947396 and in the framework of fixed time slots specified in the tariff conditions. This way of driving energy storage means in thermal form in existing electrical networks is not fully satisfactory in that it does not take into account, in a short time span, the reality of production hazards, in particular those incurred by intermittent production sources.

This invention falls within the scope of so-called “smart grids”.

### SUMMARY OF THE INVENTION

The object of this invention is to at least partly overcome the problems mentioned earlier by providing a device for driving at least one subassembly capable of transforming electrical energy and of storing it in thermal form comprising at least one power electric load. The device is designed, according to an initial feature, for receiving a setpoint whose reception triggers the supply by the device to the at least one subassembly capable of transforming electrical energy and of storing it in thermal form, of a predetermined amount of electrical energy from a terminal installation of an electrical network comprising an electrical energy meter behind which the device is connected.

One of the advantages of the invention over the solutions known by any ordinary skilled person in the art is that the amount of electrical energy consumed is known independently of the energy metering system of the relevant terminal installation. This makes it possible for example to store electrical energy in different contractual and economic frameworks to those governing the energy supply for other uses. This is made possible by the ability of the invention to offset energy consumption relative to its implementation within overall metering and the corresponding billing of the terminal installation. The invention is used for storing electrical energy at any time according to the needs of the electrical network and for automatically managing the related impact on billing. Decoupling made possible between the accounting of the overall consumption of an installation and the consumption resulting from the implementation of the invention within this installation also allows the provision of an electrical hot water supply and/or heat supply service separate from that of the electricity supply itself. Another advantage of the invention over the solutions included in the prior art is its low bandwidth requirement for the transmission of setpoints. The transmission of one single setpoint is sufficient to supply a given amount of electrical energy. The reception of the setpoint by the device determines the start of the energy supply. Stopping of the energy supply is managed locally by the device when the amount of energy provided has been consumed. The necessary bandwidth is further reduced as the large amounts of energy to be stored in an electrical network assume the commissioning of a very large number of systems according to the invention. It is thus possible to transmit the setpoint as a general broadcast in one or more branches of the telecommunications network associated with the implementation of the invention. The transmission of a single command may thus trigger the consumption of a large predetermined amount of electrical energy combining the consumption of a plurality of installations comprising one or more systems according to the invention.

The device according to the invention provides that the amount of electrical energy supplied to the at least one subassembly capable of transforming electric energy and of storing it in thermal form is estimated on the basis of the measurement of the time during which the electric energy is supplied at a predetermined power, to the at least one subassembly capable of converting electrical energy and of storing it in thermal form. The power of the driven load can be predetermined in the device by any means such as for example factory construction in the framework of systems according to the invention forming a complete apparatus. The power of the load can also be adjusted or be part of a learning step during installation of a device according to the invention for driving an external power load. This implementation variant of the invention is advantageous when the means for transforming electrical energy in thermal form operate at constant power when supplied at constant voltage. Thus, measuring the energy consumed by the driven load is tantamount to metering the running time of this load. A proportionality factor allows the bijective passage of the amount of time to the amount of energy. Refinements aiming to ensure and/or improving the accuracy of the time-energy conversion may be necessary to have the right to use the invention in the context of economic transactions. It is thus provided to calibrate the time-energy conversion factor in the factory with storage of the calibration result in a non-volatile memory of the device, so as to offset the insufficiently accurate tolerance on the unit power of means for transforming electrical energy in thermal form. It is also provided to offset the possible variation of the unit power of means for transforming electric power between a cold start and the temperature reached in steady state.

It is also provided that the estimation of the amount of electrical energy supplied to the at least one subassembly capable of transforming electric energy and of storing it in thermal form takes into account the supply voltage of the at least one power electric load. This refinement allows to take into account the fact that the supply voltage of the electrical network may not be always at its nominal voltage, which is 230 V in Europe and 110 V in North America. Thus the correspondence factor between time and energy is automatically and appropriately modified for the conversion to remain in the desired range of accuracy to within a given range of variation of the supply voltage. In the framework of driving by the device of a power load whose supply may have been interrupted by a thermostat or any other component or intermediately controlled subassembly, the device advantageously takes account of the supply voltage of the power load to pause or resume the time metering of the operation time of the load in the framework of the evaluation of the amount of electrical energy supplied. For example, a simple voltage divider or an optocoupler supplied in parallel with the power load allows the microcontroller embedded in the device to detect if the load is actually supplied or not depending on whether the mains voltage is present or not at its terminals. When the same microcontroller is used for the implementation of the invention and, for example, for setting the temperature by control of the power load in all or nothing, then the pause or resumption of metering of the operation time is programmed by the software executed by the microcontroller of the device.

The device according to the invention also provides that the amount of electrical energy supplied to the at least one subassembly capable of transforming electrical energy and of storing it in thermal form is calculated on the basis of the measurement of the power consumed by said subassembly capable of transforming electrical energy and of storing it in thermal form for the time during which the electrical energy is supplied. This implementation variant comprises a power measuring subassembly taking into account the current flowing in the load and its supply voltage.

It is provided that the device further comprises first means for driving the first means for transforming the electric energy in thermal form by Joule effect, and second means for driving the second means for transforming electrical energy in thermal form, said first means for transforming the electric energy in thermal form having a higher electric power than said second means, it being possible to drive said first and second means separately and/or jointly. Said first and second means for transforming electric energy in thermal form are comprised in the at least one subassembly capable of transforming electrical energy and of storing it in thermal form according to the invention. It is provided that said first and second means for transforming electric energy in thermal form are implemented as physically separate subassemblies designed for adding capacity or in the same physical subassembly. For example it can be the series assembly in the hot water production installation of a building, a conventional hot water tank where water is heated by a resistor and a storage water heater where the water is heated by a thermodynamic group. It is also provided that it can be a device combining both said means for heating the same volume of material for storing heat. The extra cost and volume caused by adding a resistor in a thermodynamic heating apparatus are low. This combination of heating means makes it possible for example to use a high-yield heating means under normal conditions of use while occasionally providing greater electric power consumption capacity for loading the electrical network more when it is necessary for its balancing.

It is provided that the device further comprises means for receiving at least one setpoint transmitted by remote control means. It is provided for example that the device comprises a subassembly receiving remote control commands from the electricity tariff management system, for example in France a TCFM receiver at 175 Hz or 188 Hz or a compatible PLC (Power-Line Communication) receiver compatible with “Linky”. It is also provided to integrate into the device a transceiving radiofrequency or PLC subassembly, directly connected or via a local Internet gateway with a so-called “M2M” (machine to machine) and/or “IoT “Internet of Things”) communications infrastructure.

The invention is also particularly bandwidth-efficient as only the transmission of an ON setpoint of the electricity load driven by the device is needed to consume a predetermined amount of energy. A unidirectional communication system simultaneously addressing several recipients is sufficient to effectively implement the invention. The setpoint can indeed be reduced to a binary order without a related setting. In this case, the simple order directly controls the switching on of the electrical load for consuming of a predetermined whole number of kilowatt hours. The shutdown of the electrical load is managed locally by the device when the predetermined amount of energy since it being set ON has been consumed. This is particularly advantageous in that it releases the control system from having to know the unit power of the load driven by each addressed device and having to manage the devices individually. It is provided to refine the implementation of the invention by making commands associated with several predetermined levels of energy amount coexist. For example, a storage command of 1 KWh, 2 KWh and 5 KWh. It is indeed not desirable to fall below the unit count index of energy meters of the installation, which is usually 1 KWh. Nor is it desirable to have excessively high predetermined amounts of energy storage because the risk of reaching the limits of storage capacity before having effectively consumed the predetermined amount of expected energy would be detrimental to the customer. In practice, for devices with a unit capacity usually between 1 and 3 KW, consumption/storage orders of 1 or 2 KWh are a good compromise between an operation time between thirty minutes and two hours. This given that the nominal heating time of a standard electric water heater starting from water at room temperature is usually approximately 4 hours regardless of its capacity (the power consumption of the heating element of each model is usually calculated to obtain a heating time of around 4 hours to bring 100% of the volume of the water it contains to the setpoint temperature). It is also provided to explicitly send the value of the predetermined amount of energy to be stored as a setting of the command when the invention is backed by a sophisticated telecommunications system that allows it. Simultaneous grouped commands for a large number of devices of different powers are thus possible. These features of the invention also help reduce the standby time in the electrical network and quickly absorb significant unforeseen electricity surpluses particularly from intermittent production sources.

It is also provided that the device appropriately receives and interprets at least one other setpoint different from the at least one setpoint for triggering the supply of a predetermined amount of electrical energy. As the at least one other setpoint is transmitted by means of remote control and/or by management systems advantageously identical to those implemented for transmitting the at least one setpoint for triggering the supply of a predetermined amount of electrical energy. For example, these can be setpoints for controlling the status of driven loads by changes in electricity tariff conditions and/or for specifically commanding the power load being set ON or OFF, and/or for offloading power loads in apparatuses, for example when the quantity of energy consumed in an electrical network exceeds the amount of energy produced.

It is provided that the device further comprises means for receiving at least one information transmitted by said electrical energy meter behind which it is connected. For example, it can be a capability for receiving information from the so-called “customer remote information” output on electronic meters deployed in France or any equivalent means enabling electrical energy meters to transmit information to external equipment. For example those used in Germany, which are based on the IEC62056-21 standard operating an infrared link, or a USB connection, a proprietary wired, optical, radiofrequency, PLC etc. connection. This information is advantageously used by the device according to the invention for conventionally driving the at least one subassembly capable of transforming electrical energy and of storing it in thermal form as part of recurrent operation, for example in off-peak hours. This information can also be used for calibrating the device according to the invention depending on the power measured by the meter when the power load is enabled and/or the amount of power that disappears from the total measured amount when the load is disabled. Information transmitted by the meter is also usable as a means of remote control of the device by the management system of the electrical network, for example according to the method described in patent FR1301944.

It is also provided that the information transmitted by said electrical energy meter is binary information taken from the status of a relay contact output usually provided in the meter to control the operation of a storage water heater at advantageous tariff levels.

It is provided that the device also comprises means for determining the amount of energy extracted from the at least one subassembly capable of transforming electrical energy and of storing it in thermal form during its use. It is a way for determining the amount of energy extracted from means of storage, for example in the framework of the provision of a hot water and/or heating and/or cooling supply service. It is provided that the amount of energy extracted from the means of storage is calculated and/or measured within the device on the basis of information from at least one sensor and/or one meter. Metering of thermal energy extracted from storage means can be done for example by taking account the temperature difference between two probes at the cold water inlet and the hot water outlet, and the volume of water that enters a water meter.

It is provided that the device also comprises means for receiving at least one information related to the volume of water extracted, and/or with the temperature of the water extracted, and/or with the incoming temperature of the water, from the at least one subassembly capable of transforming electrical energy and of storing it in thermal form during its use. For example, it is provided to receive the pulses of a water meter equipped with a dry contact output and/or the signal of at least one temperature sensor placed in appropriate places of the water circuit related to the extraction of the stored thermal energy.

It is provided that the device also comprises means for transmitting to an information system at least one information related to the status of the at least one subassembly capable of transforming electrical energy and of storing it in thermal form. The invention can be used within a management system transmitting unidirectionally and unconditionally to the devices according to the invention setpoints most often taking the form of a simple remote control order. In this case, it is up to the external management system to keep energy accounts of each device or execute a model to know or estimate the amount of stored energy, and where appropriate, the amount of energy that may still be stored, under the control of each device according to the invention. When the invention is implemented in an electrical network backed by a bidirectional telecommunications system with an individual addressing capacity, the status of each device can be advantageously reported to the management system in order to ensure more accurate management of available capacity at any time.

According to the level of detail of the status of the at least one subassembly of which the device according to the invention is informed and according to the possibilities of the transmission system of the back channel, it is provided for example that each device informs a management system of the amount of accumulated energy, where appropriate, according to each mode implemented, of the amount of energy that can still be stored. It can also be binary status information such as “maximum storage capacity reached”, “maximum reserve storage capacity reached” . . . . Other information of interest, where appropriate, can also be transmitted by each device to a management system, for example the amount of heat extracted, the amount of water extracted, the temperature of extracted and/or incoming water . . . .

According to another aspect of the invention, a system is provided capable of transforming a predetermined amount of electrical energy and of storing it in thermal form. The system according to the invention comprises a driving device according to the invention and at least one subassembly capable of transforming electrical energy and of storing it in thermal form. It is provided that the system according to the invention takes the form of at least two separate apparatuses, the control apparatus that constitutes the driving device according to the invention and at least one apparatus ensuring the transformation of electrical energy into heat and its storage in thermal form. It is also provided that the system according to the invention comprises at least one apparatus in the same casing, the driving device according to the invention and one apparatus ensuring the transformation of electrical energy into heat and its storage in thermal form. This device can be supplemented by additional transformation and/or storage means. The functional link between the device according to the invention and at least one subassembly capable of transforming electrical energy and of storing it in thermal form is for example provided by the electrical connection of the power cables of a storage water heater at the output of the device or an external power relay controlled by the device according to the invention. It is also provided that the functional link between the driving device according to the invention and the driven load is done via a remote control by radio frequency or PLC. In this case, the at least one subassembly capable of transforming electrical energy and of storing it in thermal form is connected to the electrical supply through at least one receiver controlled remotely by the device according to the invention inside the building. The implementation variant in the form of a separate driving device is particularly suitable for the renovation of an existing installation already comprising a storage water heater while the implementation in the form of a device with integrated driving according to the invention tends to target new optimized apparatuses for making best use of the invention.

It is also provided in the system according to the invention that the at least one subassembly capable of transforming electrical energy and of storing it in thermal form comprises means for converting electrical energy in thermal thermodynamic form and ways for converting electrical energy in thermal form by Joule effect. Thermodynamic means are preferred for their high yield, their ability for producing hot or cold according to needs. However, their operation is limited and even impossible outside a given range of temperature of the external exchanger. The invention provides for advantageously completing means of production of thermal energy for storage by heating means by Joule effect for increasing or supplementing thermodynamic production. The use of the invention in the framework of the management of the electrical network, either for storing surplus of energy sources from intermittent production or for loading the electrical network, for example, correcting a problem of increased frequency, requires rapid mobilization of high cumulated load power. This objective is more quickly reached by implementing means of heating by Joule effect in systems according to the invention. Moreover, the marginal cost of adding an armored resistor or resistor on an insulation medium in an apparatus whose main thermodynamic thermal energy is low.

It is also provided in the system according to the invention that said subassembly capable of transforming electrical energy and of storing it in thermal form stores energy in the form of heat relative to room temperature. The aim is to produce and store heat in all suitable materials.

It is also provided in the system according to the invention that said subassembly capable of transforming electrical energy and of storing it in thermal form stores energy in the form of cold relative to room temperature.

It is also provided in the system according to the invention that the at least one subassembly capable of transforming electrical energy and of storing it in thermal form stores energy in a volume of liquid mainly consisting of water. For storing heat or cold, it is provided for example to use a volume of water used directly and/or as a heat transfer fluid in which are immersed the means to produce thermal energy. In closed hydraulic circuits, it is provided to add antifreeze and/or chemical products to the water to prevent the formation of sludge.

It is also provided in the system according to the invention that the at least one subassembly capable of transforming electrical energy and of storing it in thermal form stores energy, at least partly, in a volume of solid and/or phase-change material. This particularly applies for storing large amounts of energy and/or for obtaining compact storage subassemblies. Solid materials are interesting for their mechanical robustness and storage at high temperature. Phase-change materials, judiciously selected on the basis of their melting temperature relative to the storage temperature and optimal use in the framework of implementation of the invention, are particularly effective in terms of compactness.

For the production of hot water for sanitation purposes, phase-change materials such as hydrated salts are particularly recommended. For example sodium acetate trihydrate which has a melting temperature of 55-58° C. and is not classified as toxic. This material can store 100 KWh between 55° C. and 58° C. in a volume more than 26 times smaller than that of water. The use of organic compounds such as paraffins and fatty acids is also provided as well as any other encapsulated phase-change materials to allow adequate kinematics of heat exchanges and safe retention of the material.

For the production of reversible storage heaters or air conditioners according to the invention, both compact and of a reasonable mass, hydrated salts with a high melting temperature are the choice phase-change materials. It may, for example, be sodium hydroxide whose melting temperature is 318° C. or any other phase-change material with a suitable melting temperature.

It is also provided to combine thermal energy storage in a volume of water and in phase-change materials as will be seen later in the examples of implementation of the invention.

It is provided that the system according to the invention also comprises metering means of energy in thermal form extracted during its use. These additional means are provided in the delivery of hot water for sanitation purposes and/or heat or cooling for air conditioning of buildings or for professional uses comprising manufacturing and/or storage methods. The implementation of the invention in this context allows decoupling of the consumption of electrical energy used for producing stored thermal energy and for its use.

It is also provided in the system according to the invention that at least a proportion of energy in thermal form extracted during its use is via an electrical current. This for example in the framework of local micro-cogeneration of heat and electric energy from the thermal energy stored. It is provided that the transformation of thermal energy released from stock in the form of electrical energy may be based on any type of known physical phenomena, for example by direct thermoelectric conversion or by indirect conversion using the principles of thermodynamics.

It is also provided in the system according to the invention that at least a proportion of energy in thermal form extracted during its use is via an air flow conveying it. This for example applies to electric storage heating or a reversible or non-reversible storage air conditioner where the heat or the cold stored is extracted as needed by an air flow produced by a fan. This for example also applies to a forced draft ventilation or turbofan, with heat or cold input and storage, depending on the season where appropriate.

It is also provided in the system according to the invention that at least a proportion of energy in thermal form extracted during its use is via a liquid flow conveying it. The liquid is running water in the production of hot water for sanitation purposes or a fluid circulating in closed circuit for heating and/or cooling of premises through fan coils with heat exchanger or tubes forming an exchanger which are embedded in walls, ceilings or floors.

It is provided that the system according to the invention also comprises means for providing an air or liquid flow at a temperature different from the temperature at which energy is stored in thermal form. For example, a chamber allowing the mixing of air flow at the temperature of energy storage means in thermal form and an air flow at room temperature to produce an air flow at an intermediate temperature. In the case of a flow of liquid, this is for example a mixer producing a liquid flow at an intermediate temperature from a liquid flow at the temperature of storage means and a liquid flow that is at the input temperature in storage means. It is provided that the means for advantageously providing an air or liquid flow at a temperature different from the temperature at which energy is stored in thermal form include thermostatic means regulating the temperature of the flow supplied at a relatively constant value. These regulation means for example are mechanical thermostatic means based on the dilation of materials or electronic regulation means also comprising at least one temperature sensor and an electromechanical actuator. Of course, these solutions are applicable to cold storage, for example in the case of cold storage in the form of latent heat storage in a phase-change material at a temperature lower than the temperature of use.

It is provided that the system according to the invention forms a storage apparatus for producing hot water for sanitation purposes.

It is provided that the system according to the invention further comprises a water meter and/or means for measuring the temperature of the water extracted and/or means for measuring the temperature of incoming water. These additional means are provided in the framework of the supply of hot water for sanitation purposes in view of its billing.

It is provided that the system according to the invention forms a storage heating and/or cooling apparatus. The invention is thus implemented in the framework of decentralized thermal energy production apparatus, like, for example storage heaters or air conditioners, or centralized apparatus like boilers or central storage heating and/or cooling systems.

It is provided that the system according to the invention is fitted in such a way as to provide at least two distinct types of storage of electrical energy in thermal form, at least one type for recurring storage and at least one type operating a reserve capacity of storage in thermal form for occasional storage.

The invention provides that the transformation of a predetermined amount of electrical energy and its storage in thermal form may coexist in the same system according to the invention with a traditional system for the transformation of a non-predetermined quantity of electrical energy and its storage in thermal form. In the case of an electrical storage water heater for example, it is the ability to function according to the invention and obtain daily production of hot water for example by having its operation controlled by the electrical energy tariff system for heating during advantageous tariff periods, for example in off-peak hours in France. This goal can be achieved in the framework of the same system according to the invention comprising a single subassembly for storing energy in thermal form, in this case the same volume of water and a single subassembly for transforming electrical energy in thermal form, in this case a submerged armored resistor or resistor on insulating medium placed in a sleeve, or a thermodynamic heat exchanger of a subassembly. However, so as not to make the absorption and storage of a predetermined amount of energy impossible due to saturation of the storage capacity in the framework of a traditional operation, it is preferred to implement the invention with additional storage capacity specifically dedicated to it. The advantage of additional storage capacity is further enhanced in the framework of implementation of the invention not comprising transmission of information on the status of the subassembly for storing energy in thermal form. In such an implementation framework, systems according to the invention are deemed to always have the capacity for storing in thermal form a new predetermined amount of electric power and related billing management cannot take into account a physical inability for storing more energy.

Additional storage capacity, all things being equal, can be advantageously created by differentiated management of the storage temperature in thermal form. For example for a storage water heater, in the framework of traditional operation of water, is heated during off-peak hours at a first given setpoint temperature, for example 65° C. The operation according to the invention is based on a second setpoint temperature higher than the first, for example 85° C. It is provided that additional heat storage capacity is greatly increased by the combined use of phase-change material with water as the storage medium of the energy in thermal form. The temperature of the phase-change material is for example located between the two setpoint temperatures so as to only store thermal energy in latent heat form in the phase-change material in the operational mode according to the invention. The second temperature is reached when the thermal storage capacities in the form of latent heat are saturated and that the material shows so-called heat storage sensitive behavior, i.e. an increase of thermal energy stored in the material causes an increase in its temperature.

It is provided that the system according to the invention also comprises means for contributing to energy input in thermal form which are not connected to the electrical distribution network. These additional means are included in said subassembly capable of transforming electrical energy and of storing it in thermal form. This may be for example electric heat production means directly connected to a local production source isolated from the network such as solar electric roof panel or a wind turbine. It may also be a heat exchanger connected to a circuit comprising a heat transfer fluid connected to solar panels, a wood stove etc. The system according to the invention also comprises, where appropriate, at least one pump ensuring the circulation of heat transfer fluids if said thermosiphon operation is not sufficient or desirable. Means are provided for managing the circulation of heat transfer fluids so that it may only generate thermal energy inputs in the storage means. Means are also provided for blocking any supply of thermal energy liable to represent a danger to people or equipment, for example in the case of saturation of the storage capacity when there is a risk of a temperature increase approaching boiling point in the material used for thermal storage.

According to another aspect of the invention, a method is provided to operate a plurality of systems according to the invention in an electrical network.

The method according to the invention comprises the steps of:
Continuous monitoring of the balance between electricity consumption and production in said electrical network by an appropriate supervision and management system;
Transmission by said appropriate supervision and management system, with a given plurality of systems according to the invention, of at least one setpoint for transformation and storage of a predetermined amount of electrical energy, for consuming an accumulated amount of predetermined electric power so as to adjust electricity consumption to production in the case of a given surplus production.

The method according to the invention also comprises the step of:
Saving, in at least one information system, of the at least one information related to the transmission by said appropriate supervisory and management system, with a given plurality of systems according to the invention, of the at least one setpoint for transforming and storing a predetermined amount of electrical energy.

The method according to the invention provides for example the storing in a database of the identification of installations comprising at least one system according to the invention to which the setpoints are transmitted, predetermined amounts of electric power associated with setpoints, the number of systems according to the invention comprised in each installation and, where appropriate, their respective nominal powers, as well as the timestamping of the transmission of setpoints. All or part of this information ensures that appropriate corrections are made in good time on energy meter index variations impacted during given billing periods.

The method according to the invention also comprises the step of:
Correcting within at least one information system, of the at least one figure in connection with the metering of electrical energy consumed in an installation where at least one system according to the invention is implemented, when the amount of electrical energy consumed by said system has been at least in part consumed while an inappropriate metering index was enabled in the metering means associated with said installation.

For example, in the case of French dual peak/off-peak tariff, if the balancing needs of the distribution network require the transmission of a setpoint for transforming and storing a predetermined amount of electrical energy during peak hours when it is provided in normal use that this is done only during off-peak hours. A retro-correction is scheduled on the customer invoice issued by the operator. This correction can for example be on the basis of metering indexes taken or estimated expressed for example in KWh before applying the tariff rules for transforming amounts of energy consumed into a monetary unit. It is also provided that this correction is done in monetary units in the calculation of the net amount payable by the customer for a given billing period, starting from the amount that would be payable by applying the tariff rules on read or estimated metering indexes. The correction provided for in the accounts of a given installation for example consists in subtracting the predetermined amount of energy or the corresponding amount in monetary units of inappropriate items, where appropriate, multiplied by the number of systems according to the invention implemented in this installation, and then adding the amounts previously subtracted to items considered more appropriate. It is also provided to correct at least one figure for applying a specific economic model to the apparatuses and/or services implemented in the framework of the invention. The invention further allows the possibility of opting for a simplified implementation variant of the device according to the invention when the corrections are calculated from a constant general amount of energy consumed as recorded over a given period by the energy meter of the installation approved for financial transactions. Indeed, under these conditions, means for estimating or measuring the amount of electrical energy supplied, which would be insufficiently accurate to allow economic transactions as such, are enough for correcting the allocation of metering results attaining the required accuracy.

The same principle is applicable to more complex pricing structures such as the 6-index “Tempo” tariff, 3 types of days and periods during peak and off-peak hours in each day. The corrections in this case require complete timestamping of the transmission of the setpoints and the memory of the tariff schedule applicable to the customer installation. Knowledge of the unit power of loads in the database containing information characterizing the systems according to the invention in the customer installation is used for recalculating the costs of operating time of loads and thus making prorata temporis corrections when the consumption period comprises index changes. In practice it will be preferred to round the corrections most favorably for the customer, both for simplifying the implementation of the invention and enhancing its acceptability.

The application of the method according to the method is provided for managing an electrical network comprising energy sources for intermittent production whose contributions are impossible to plan reliably such as wind turbines, photovoltaic panels, solar power plants where electricity is generated by thermodynamic means, etc.

The application of the method according to the invention is provided in the framework of a service for acquiring and storing electrical energy produced in surplus and for supplying corresponding thermal energy in premises in an appropriate form. The aim is to organize and manage a storage system comprising a plurality according to the invention, to use it by implementing the method according to the invention in order to consume surplus production liable to unbalance an electricity network for reselling the stored energy in thermal form.

The application of the method according to the invention is provided in the framework of a service supplying hot water for sanitation purposes and/or heating and/or cooling and/or electricity. These supplies are intended for domestic or business premises or in the framework of industrial processes.

### BRIEF DESCRIPTION OF THE DRAWINGS

Other features and advantages of the invention will appear on examining the detailed description of implementation modes, which are in no way limiting, and appended drawings where:

FIG. 1 illustrates a first variant of the block diagram of the device.

FIG. 2 illustrates a second variant of the block diagram of the device.

FIG. 3 illustrates a first variant of the system in separate elements.

FIG. 4 illustrates a second variant of the system in separate elements.

FIG. 5 illustrates a third variant of the system in separate elements.

FIG. 6 illustrates a fourth variant of the system in separate elements.

FIG. 7 illustrates a first integrated variant of the system.

FIG. 8 illustrates a second integrated variant of the system.

FIG. 9 illustrates a third integrated variant of the system.

FIG. 10 illustrates a fourth integrated variant of the system.

FIG. 11 illustrates a first variant of integrated water heater.

FIG. 12 illustrates a second variant of integrated water heater.

FIGS. 13a and 13b illustrate an integrated electric heating variant.

FIG. 14 illustrates the steps of the method related to the balance of the network.

FIG. 15 illustrates the steps of the method related to the valuation.

### DETAILED DESCRIPTION OF FIGURES AND EMBODIMENTS

Other specific features and advantages of the invention will appear in the description below. In appended drawings given as non-limiting examples:

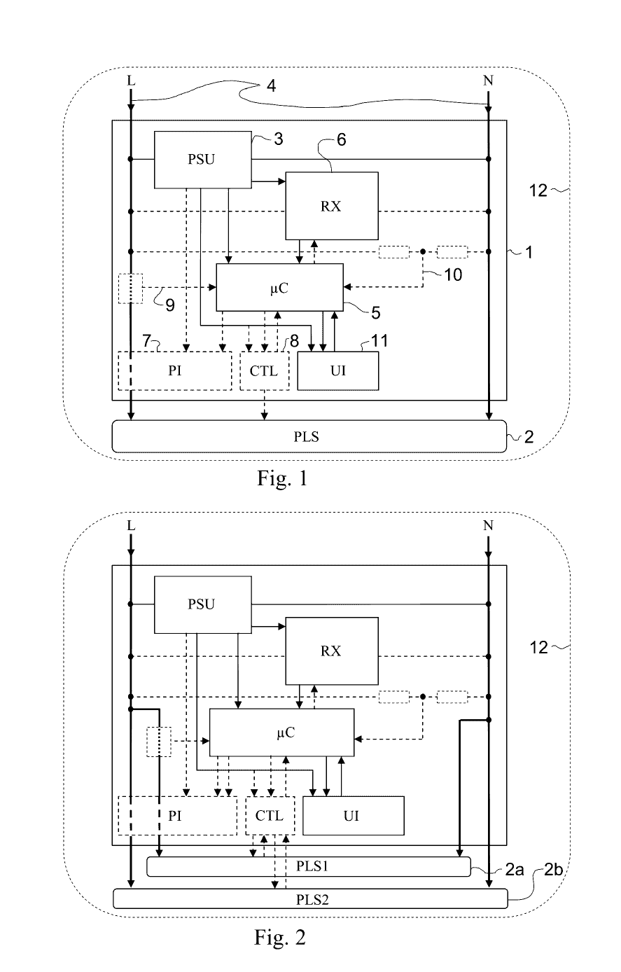

FIG. 1 illustrates a first variant of the block diagram of the system.

The block diagram of the system 12 comprises a device 1 according to the invention for driving at least one subassembly capable of transforming electrical energy 2 and of storing it in thermal form comprising at least one power electric load. Device 1 comprises a low voltage power supply subassembly 3 providing the voltage required for the operation of the other subassemblies from the voltage of the electrical installation 4 to which it is connected. At the heart of the device is the microcontroller 5 which controls the resources of the device through software contained in its program memory, a working RAM memory and a non-volatile memory for permanent storage of operating settings and functional statuses, where appropriate. Models of the “tiny” 8 bit AVR microcontroller family from Atmel, registered trademarks, or models of the “MSP430” 16 bit microcontroller family from Texas Instruments, registered trademarks, are particularly preferred, but several other acceptable references are also available also at other semiconductor manufacturers. A communication subassembly 6 ensures at least the reception of the setpoint which triggers the supply of a predetermined amount of electrical energy. The use of all types of physical media and communication protocol is provided in the framework of the invention. It is also provided to use a transceiver capable of receiving and transmitting information to make the device compatible with certain telecommunications standards requiring bidirectional exchanges. When the at least one subassembly capable of transforming electrical energy 2 and of storing it in thermal form is an electric load not comprising power switching means or not comprising an interface enabling the device 1 to remote control it, switching means are integrated into a power interface 7. The power interface 7 comprises for example at least one electromechanical or static power relay and its control electronics. Otherwise, the power supplied by the electrical network, via the means for measuring the current, where appropriate, is supplied directly to the at least one subassembly capable of transforming electrical energy 2 and of storing it in thermal form. It is also provided that at least one subassembly of driven power may be remote controlled by the device via any conventional unidirectional or bidirectional control means 8. The control means 8 communicate with the at least one subassembly capable of transforming electrical energy 2 and of storing it in thermal form, for example by “pilot wire”, power-lines, radio frequency, infrared or by any wire means. This allows use of power switching means external to the device which are already implemented in driven apparatuses, for example for controlling the at least one power electric load within the at least one subassembly capable of transforming electrical energy 2 and of storing it in thermal form or for regulating its temperature. In addition, when the device according to the invention does not comprise means for measuring the electric power supplied, it is provided to acquire a signal in relation to the supply voltage of the power load. This refinement makes it possible to integrate the power in the calculation for estimating the energy provided only when the at least one power electric load is actually supplied. It also, where appropriate, allows to take into account variations in the supply voltage with respect to its nominal value for correcting the estimate of the energy supplied, for example by application of a proportionality factor or corrections extracted from a table at the value of the nominal power of the at least one power electric load.

According to the variants implemented for estimating or measuring the energy supplied, the device comprises means 9 for knowing the circulating current in the at least one subassembly capable of transforming electrical energy 2 and of storing it in thermal form and/or means 10 for knowing its supply voltage. Depending on the types of implementation, the means 10 collect voltage information at the most relevant place. For example at the main power supply from the electrical installation 4 as in FIG. 1 or directly at the terminals of the power loads within the block 2.

In the diagram of FIG. 1, the same microcontroller 5 is provided to implement all aspects of the invention including for measuring the power consumed by the at least one subassembly capable of transforming electrical energy 2 and of storing it in thermal form, where appropriate. Of course the skilled person in the art will understand that all the well-known solutions for measuring power or electrical energy relying or not on the use of specialized integrated external circuits for metrology, for example using a shunt for measuring current, a current transformer, a Hall-effect sensor, a Neel-effect sensor, a Rogowski coil sensor can also be used without departing from the scope of the invention.

A user interface 11 comprising at least one push button and one light indicator allows interaction between the device and the user.

As the systems according to the invention comprise means for storing energy, it is often useful for the user to benefit from “gauge” information for providing knowledge on the status of embedded storage capacity.

FIG. 2 illustrates a second variant of the block diagram of the system.

This figure differs from the previous one in that it comprises two subassemblies capable of transforming electrical energy 2a and 2b and of storing it in thermal form. This variant corresponds to the case of a system 12 according to the invention forming an apparatus offering two modes of consumption of electrical energy. The mode of consumption according to the invention when it comes to transforming a predetermined amount of electrical energy and storing in thermal form is combined with a traditional way of consumption, not limited to a predetermined value of the amount of electrical energy supplied to the load by the device according to the invention. This block diagram corresponds for example to a heating or cooling apparatus comprising a subassembly transforming and storing energy driven according to the invention over a traditional subassembly immediately supplying heat or cold without storage. For example, a heater with an immediate action traditional radiant panel to which a storage capacity is added for deferred use of the stored heat. Another example is an air conditioner containing in the same apparatus a subassembly capable of providing immediate high energy efficient service by thermodynamic means and a thermal heat and/or cold storage subassembly. It is also provided that some or all of the power subassemblies, especially the one that is intended to provide immediate service is remote-controlled by the device via any conventional means, for example by “pilot wire” or wireless remote control means.

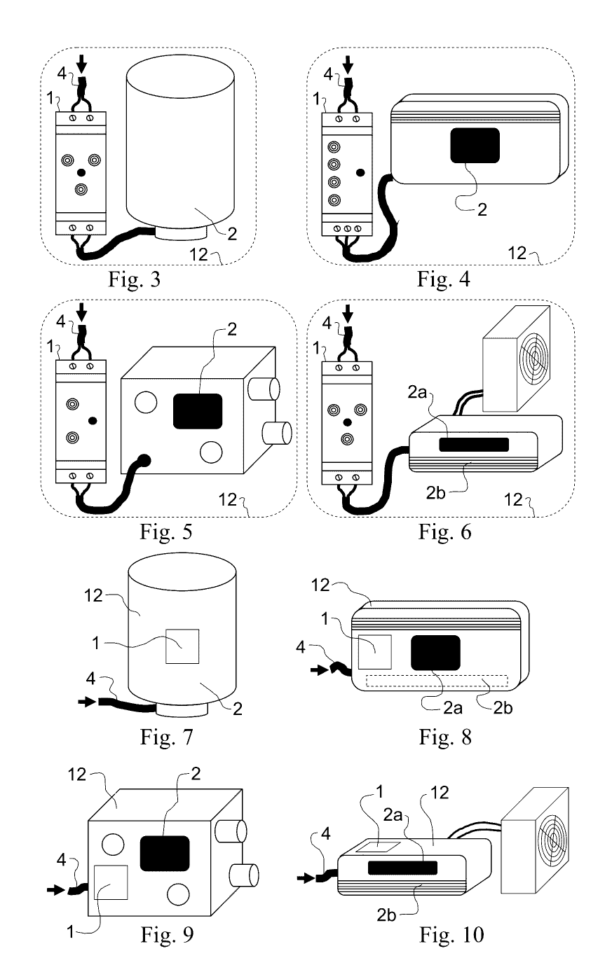

FIG. 3 illustrates a first variant of the system in separate elements.

The system according to the invention 12 is implemented in the form of two separate apparatuses 1, 2. The system according to the invention in this example forms a production system for storage hot water for sanitation purposes. The device according to the invention 1 connected to the electrical network 4 and the at least one subassembly capable of transforming electrical energy 2 and of storing it in thermal form. The at least one subassembly capable of transforming electrical energy 2 in thermal form comprises in this example an electric resistor or thermodynamic heating means and a thermostat regulating the temperature of the water as well as, where appropriate, a separate safety thermostat. The at least one subassembly capable of storing energy in thermal form here is a tank comprising a volume of water.

FIG. 4 illustrates a second variant of the system in separate elements.

The system according to the invention 12 is implemented in the form of two separate apparatuses 1, 2. The system according to the invention in this example forms a storage or mixed heater, i.e. storage and instant heating. The device according to the invention 1 connected to the electrical network 4 and the at least one subassembly capable of transforming electrical energy 2 and of storing it in thermal form. The at least one subassembly capable of transforming electrical energy 2 in thermal form comprises in this example an electric resistor and a thermostat regulating the temperature of the material used for the storage of energy in thermal form, where appropriate, a separate safety thermostat. The at least one subassembly capable of storing energy in thermal form is here a solid material volume and/or phase-change material in a suitable casing, completed by means for extracting and delivering the stored heat.

FIG. 5 illustrates a third variant of the system in separate elements.

The system according to the invention 12 is implemented in the form of two separate apparatuses 1, 2. The system according to the invention in this example forms a “forced draft” ventilation or “turbofan” system. These active ventilation systems designed for the renewal of the air inside buildings are characterized in that fresh air is drawn from the outside and distributed inside the premises. These ventilation systems advantageously comprise means for heating or preheating the air distributed in the premises. These devices typically installed in the attic or in technical premises are not constrained by their physical size. They can therefore be advantageously integrated in thermal energy storage means for implementation of the invention. The device according to the invention 1 connected to the electrical network 4 and the at least one subassembly capable of transforming electrical energy 2 and of storing it in thermal form. The subassembly 2 comprises in this example an electric resistor and a thermostat regulating the temperature of the material used for the storage of energy in thermal form, where appropriate, a separate safety thermostat. The at least one subassembly capable of storing energy in thermal form is here a solid material volume and/or phase-change material in a suitable casing, completed by means for extracting and delivering the heat stored in the distributed air flow.

FIG. 6 illustrates a fourth variant of the system in separate elements.

The system according to the invention 12 is implemented in the form of two separate apparatuses 1, 2. The system according to the invention in this example forms a storage or mixed air-conditioning system, i.e. storage and instant heating or cooling. Air conditioning systems can advantageously implement the invention for storing cold and/or heat at appropriate times for later use as needed. Such apparatus naturally lends itself to the implementation of the invention in that it already comprises sophisticated embedded management means and the means for generating and driving an air flow. The device according to the invention 1 connected to the electrical network 4 and the at least one subassembly capable of transforming electrical energy 2a, 2b and of storing it in thermal form. The at least one subassembly capable of transforming electrical energy 2a, 2b in thermal form comprises in this example a heat exchanger in the case of thermodynamic heating means and an electric resistance, a thermostat regulating the temperature of the material used for storing the energy, as well as, where appropriate, a separate safety thermostat. The at least one subassembly capable of storing energy in thermal form is here a phase-change material volume owing to its compactness and low mass. Indeed, the part of an air conditioner which is located in premises is often suspended on the upper section of a wall. The volume of phase-change material is comprised in a suitable casing completed by means for extracting and delivering the cold or the heat stored in the air flow coming out of the air conditioner.

FIG. 7 illustrates a first integrated variant of the system.

This example of the system according to the invention 12 differs from that of FIG. 3 in that it takes the form of a unique apparatus according to the invention, in this case, a storage domestic water heater, in which the device 1 and the at least one subassembly capable of transforming electrical energy 2 and of storing it in thermal form are integrated in the same casing.

FIG. 8 illustrates a first integrated variant of the system.

This example of the system according to the invention 12 differs from that of FIG. 4 in that it takes the form of a unique apparatus according to the invention, in this case, an electric storage water heater, in which the device 1 and the at least one subassembly capable of transforming electrical energy 2a, 2b and of storing it in thermal form are integrated. In this variant, an instant heating subassembly 2b, for example by convection, by a resistive radiant or by infrared subassembly coexists with a storage heat production subassembly.

FIG. 9 illustrates a first integrated variant of the system.

This example of the system according to the invention 12 differs from that of FIG. 5 in that it takes the form of a unique apparatus according to the invention, in this case, a centralized mechanical ventilation apparatus comprising storage heating means in which the device 1 and the at least one subassembly capable of transforming electrical energy 2 and of storing it in thermal form are integrated.

FIG. 10 illustrates a first integrated variant of the system.

This example of the system according to the invention 12 differs from that of FIG. 6 in that it takes the form of a unique apparatus according to the invention, in this case, a heat and/or cold storage air-conditioning apparatus, in which the device 1 and the at least one subassembly capable of transforming electrical energy 2a, 2b and of storing it in thermal form are integrated.

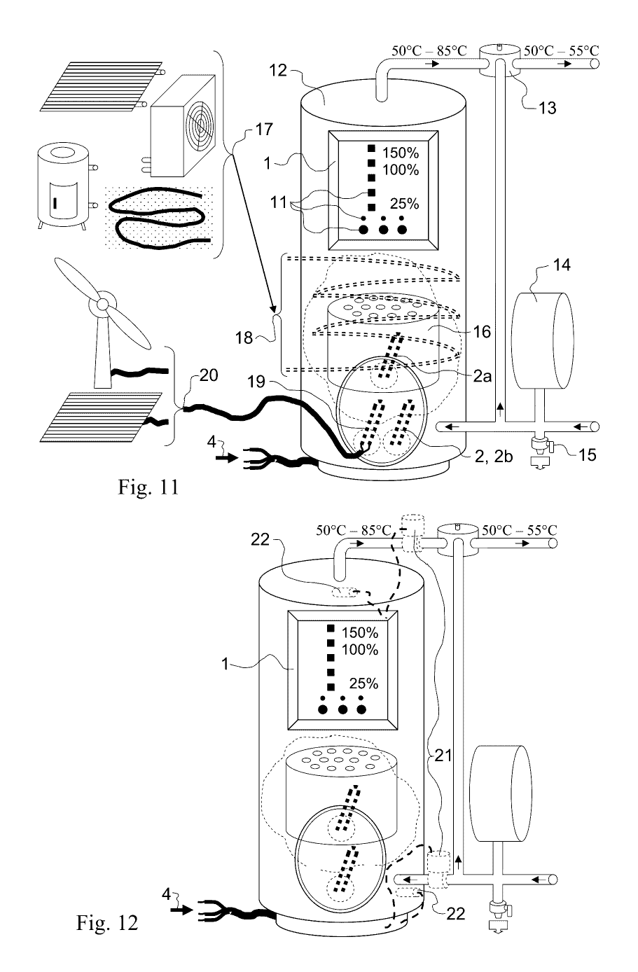

FIG. 11 illustrates a first variant of integrated water heater.

This example illustrates a storage water heater according to invention 12, which also offers traditional recurring storage-type operation during off-peak hours of the electricity tariff. As the two modes are managed by a device according to the invention 1 integrated in the casing of the water heater and connected to the electrical network 4. The device comprises means of interaction with the user 11 including display means indicating the status of storage capacities. A first subvariant provides to only use one single resistance 2 for both traditional modes of operation and according to the invention as well as the same tank containing water only.

A thermal energy storage tank is especially dedicated to the implementation of the invention, without significant modification of an ordinary hot water tank. The goal is achieved by proper management of the temperature of the hot water produced. In this example, the water is heated daily during off-peak hours to a first setpoint temperature of the thermostat, for example 65° C. When a setpoint for transforming and storing a predetermined amount of electrical energy in thermal form is received by the device, the operation according to the invention is done on the basis of a second setpoint temperature of the thermostat which is higher than the first, for example 85° C. The increase in thermal energy thus stored is expressed by an increase in the volume of hot water stored at the outlet of a thermostatic mixer 13 which produces an intermediate water temperature close to the first setpoint temperature by adding cold water to the water stored at the second setpoint temperature. The thermostatic mixer also improves the safety of users of the apparatus by eliminating any risk of burning people incurred by very hot water. The thermostatic mixer can be mounted as a component outside the water heater in the same way as the expansion tank 14, needed to prevent loss of water through the safety valve during heating cycles with faucets closed, or the safety group 15. The mixer can also be advantageously pre-assembled and integrated into the casing of the apparatus as all or part of the other essential accessories to form a complete apparatus, taking advantage of a general thermal insulation of all its components inside an attractive casing. The apparatus implementing the invention is thus ready for example to replace an old model with same footprint, as the hydraulic and electrical connections are advantageously designed to be directly compatible with those of traditional models.

A subvariant using a phase-change material volume 16 is also provided. Its melting temperature is chosen between two thermostat setpoint values seen earlier. The introduction of this material contained in appropriate casing for allowing effective heat exchanges, greatly increases the additional storage energy capacity according to the invention, for example, if necessary, to such a point as to dispense with traditional heating mode in off-peak hours to only consume electrical energy produced by sustainable sources through intermittent production if the invention is implemented by the network operator to store unexpected surpluses. The compactness offered by the use of phase-change materials in view of their large storage capacity for energy in the form of latent heat allows the implementation of the invention in electric water heaters with large footprints and masses similar to the classic models for a given capacity expressed in liters of water.

Another subvariant also provides that the means for transforming electrical energy in thermal form used in the framework of the invention 2A and for heating in traditional mode 2B are differentiated. This specialization is even more interesting if the solution for traditional heating offers high energy efficiency, for example a thermodynamic heat production subassembly. As heating by Joule effect is preferred for storage according to the invention in that maximizing the power of the electrical load contributes to more effectively balancing demand based on production in the electrical network. This implementation variant also provides for optional external thermal energy inputs 17 by means of a heat exchanger 18 placed in the common storage volume. These inputs can come for example from any source of heat, thermal solar panels, heat pumps, geothermal, gas, wood or oil boiler, urban heating network etc. It is provided that the flow of the heat transfer by a circulation pump or by thermosiphon is done when the contribution of the external source is positive. At least one means is also provided for transforming electrical energy in thermal form 19 connected directly to a source of local production 20 not connected to the electrical network like for example a wind turbine or electric solar panels. Security features are also provided for blocking the energy inputs in order to prevent water, and/or phase-change material, where appropriate, from reaching dangerous temperatures for people or equipment.

FIG. 12 illustrates a second variant of integrated water heater.

This variant differs from FIG. 11 in that it is specifically dedicated to the supply of hot water for sanitation purposes by a possibly different operator that the one supplying the electrical energy of the installation. It can be for example an operator specialized in the supply of water which can, through the implementation of the invention, add the supply of hot water for sanitation purposes to its traditional customers already billed for a similar service. This operator can also provide services for the consumption of a predetermined amount of electrical energy and/or load shedding services to the manager of the electrical network, at times where it suits the latter. The operator can buy electrical energy from the electricity distributor supplying the installation, the latter refunding its customer the corresponding amounts/sums in its billing. The operator may also have no connection with the electricity of its customer and deduct from its own bills the cost of electricity to refund its customer. Electricity costs charged to the joint customer by the distributor in the framework of its overall consumption of electrical energy can be easily refunded when the amounts of electricity consumed for the implementation of the invention, corresponding timestamps and tariff subscribed by the customer from its electricity distributor are known as the latter are public. The means comprised in this variant of the device according to the invention for receiving setpoints may be specific to this operator, for example by being connectable to a “Machine to Machine” type telecommunications network infrastructure with the main purpose of remotely metering water, gas meters, heat etc. with respect to the services provided by that operator. This can be a standard cellular type radiofrequency or a specific medium-range network with appropriately distributed hubs or a short-range radiofrequency network connected, for example, to an internet box in the customer's premises, or specific proximity hubs or standard “Femtocell” type telecommunications access points. In this perspective, the technical solutions of the invention rely on a unique source of electrical energy 4 whose cost can be known and managed as well as on metering means allowing the operator in question to bill the hot water supply service. The most accurate billing method to do it in units of energy, for example in KWh, delivered in the form of hot water so that the price includes both the volume of hot water consumed during a given period, but also the temperature at which the hot water was supplied. This, for example, requires the addition of a volumetric meter 21, preferably installed on the cold water inlet to increase the longevity of the material, and two temperature sensors 22 placed near the cold water inlet and the hot water outlet. The microcontroller in the device according to the invention 1 calculates the thermal energy extracted from the stock on the basis of information provided by the temperature sensors and information received from the pulse output of the volumetric meter. The quantity of extracted water recorded over the billing period by the device is advantageously transmitted to the operator information system to be deducted from the general cold water consumption of the customer recorded at the top of their hydraulic network and for which a meter reading is taken.

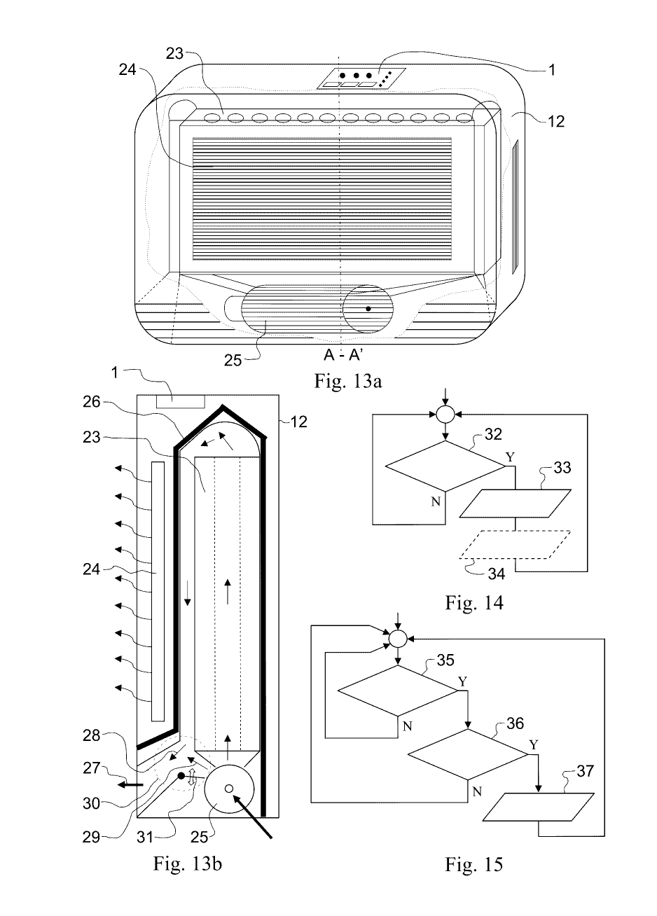

FIGS. 13a and 13b illustrate an integrated electric heating variant. FIG. 13A shows the front view of the apparatus and FIG. 13b a cross-section of this same apparatus along the A-A′ axis. This variant of the system according to the invention is an electric heater 12 with both thermal energy storage capacity 23 for deferred release of heat and instant heat production means 24. This variant is particularly advantageous in that the user benefits from continuous heating if necessary and without noticeable inertia. The device according to the invention 1 is equipped to heat with instant heat production means when the previously stored heat has been consumed and it is still necessary to heat the room. Given the small footprint of a standard heater which it is desirable to target, the storage of a large amount of thermal energy requires the use of phase-change material with a high melting temperature, for example between 250 and 350° C. At such temperatures, only electric heating by Joule effect is technically suitable, for example implemented in the form of at least one armored resistor in a stainless steel sheath which is immersed in the phase-change material. The stored heat is actively extracted through a centrifugal fan 25 driven by the device 1. The circuit used by the air flow is studied to remove any leakage of heat by convection when the exhaust fan is stopped. The high temperature thermal storage subassembly is mounted in the carcass of the apparatus so as to avoid leakage of heat by thermal bridges and is completely temperature-insulated by appropriate 26 materials. The resulting air flow 27 must have a relatively low temperature to ensure personal comfort and safety. Producing a resulting air flow at the outlet of the apparatus which is at the right temperature, from air heated to high temperature 28 in contact with the casing of the phase-change material requires it to be mixed with an air flow at room temperature 29. A mixing chamber 30 is provided which also advantageously comprises means of adjusting the mix, such as a valve 31, whose position is controlled to regulate the temperature of the air flow 27 resulting from the mixture.

The solutions presented in this implementation example are largely transposable to the case of the air conditioner and that of thermal energy storage ventilation systems, whether it be a capacity to store heat or cold according to the variants of apparatuses.

FIG. 14 illustrates the steps of the method for producing actions allowing the implementation of the invention in terms of balancing energy production and demand in an electrical network by acting on demand.

In the framework of continuous monitoring of the balance between energy produced and energy consumed within an electrical network, the energy produced is continuously compared 32 to energy consumed. If the amount of energy produced exceeds the amount of energy consumed (result Y in test 32), the monitoring and management means of the electrical network transmit 33, to a plurality of systems according to the invention dispersed throughout the network, a consumption setpoint of a predetermined amount of energy so as to adjust the amount of energy consumed to the amount of energy produced in the network. Prior to transmission of appropriate remote control commands to the systems according to the invention, the monitoring and management means of the electrical network calculate the accumulation of additional energy consumption it must order to balance the network. It substantially corresponds to the difference between the cumulative energy produced and the energy consumed in the network. Monitoring and management means of the electrical network, by requests in a database identifying the systems according to the information, determine their address in the telecommunications network which is backed by the electrical network, by remote control, where appropriate, their nominal unit and/or residual energy storage capacity if the telecommunications network is bidirectional, the nominal power of the electrical load involved in the transformation of electrical energy into thermal energy with a view to its storage and by the execution of appropriate algorithms taking into account addressing possibilities in the telecommunications network to remotely control relevant systems according to the invention. An additional step 34 is provided in the method to record the event in a database. This event is the fact that a determined system according to the invention, linked to a customer account, received, at a given date and time, a remote control order to consume a predetermined amount of electrical energy. This step 34 targets the saving of information needed later in the framework of the operation of the invention from an economic perspective. The invention further provides that means to offload managed power loads should it appear that demand for energy in the electrical network exceeds production, must be implemented in the same apparatuses and in the same related management systems. The marginal cost of this functional addition is practically zero as it relies on the use of the same physical means as the invention and only the software embedded in devices 1 and in related management systems needs to be modified in consequence.

FIG. 15 illustrates the steps of the method for producing information allowing the operation of the invention from an economic perspective.

When an invoice needs to be produced (result Y in test 35), for a given customer in respect of a given consumption period, a database is explored which stores time-stamped events that are the remote control transmission of orders to consume a predetermined amount of electrical energy according to the invention. If this exploration of the database reveals events resulting from the implementation of the invention for the given customer on the consumption period (result Y in test 36), processes 37 are performed to appropriately correct billing given the fact that said events resulted in energy consumption that was metered in at least one index associated with given tariff conditions. In this way, the economic effects, according to the general tariff conditions applicable during the relevant consumption period, resulting from the implementation of the invention can be erased and replaced by others, as these economic effects are determined by the application of tariff conditions specifically applicable to energy consumption resulting from the implementation of the invention. It is also provided, where appropriate, to correct billing of the consumption of cold water in the framework of a supply of hot water.

Of course, the invention is not limited to the embodiments described above and many modifications can be made therein without departing from the scope of the invention, in particular by combining several variants in the same implementation or by differently combining elements taken from several examples.

1. Device (1) for managing at least one subassembly capable of transforming electrical energy (2) and of storing it in thermal form comprising at least one power electric load, the device being designed to receive a setpoint whose reception triggers the supply by the device to the at least one subassembly capable of transforming electrical energy (2) and of storing it in thermal form, of a predetermined amount of electrical energy from a terminal installation of an electrical network comprising an electrical energy meter behind which the device is connected.

2. Device according to claim 1, wherein the amount of electrical energy supplied to the at least one subassembly capable of transforming electric energy and of storing it in thermal form, is estimated from the measurement of time during which the electric energy is supplied at a predetermined power, to the at least one subassembly capable of transforming electric energy and of storing it in thermal form.

3. Device according to claim 2, wherein the estimation of the amount of electrical energy supplied to the at least one subassembly capable of transforming electrical energy and of storing it in thermal form takes into account the supply voltage of the at least one power electric load.

4. Device according to claim 1, wherein the amount of electrical energy supplied to the at least one subassembly capable of converting electric energy and of storing it in thermal form, is calculated from the measurement of power consumed by said subassembly capable of transforming electric energy and of storing it in thermal form, for the period in which electrical energy is supplied to it.

5. Device according to claim 1, further comprising first means for driving the first means for transforming electric energy in thermal form by Joule effect, and second means for driving the second means for transforming electrical energy in thermal form, said first means for transforming the electric energy in thermal form having a higher electric power than said second means, it being possible to drive said first and second means separately and/or jointly.

6. Device according to claim 1, further comprising means for receiving at least one setpoint transmitted by remote control means.

7. Device according to claim 1, further comprising means for receiving at least one information transmitted by said electrical energy meter behind which it is connected.

8. Device according to claim 1, further comprising means for determining the amount of energy extracted from the at least one subassembly capable of transforming electrical energy and of storing it in thermal form during its use.

9. Device according to claim 1, further comprising means for receiving at least one information linked to the volume of water extracted, and/or with the temperature of the water extracted, and/or with the incoming temperature of the water, from the at least one subassembly capable of transforming electrical energy and of storing it in thermal form during its use.

10. Device according to claim 1, further comprising means for transmitting to an information system at least one information relating to the status of the at least one subassembly capable of transforming electrical energy and of storing it in thermal form.

11. System (12) capable of transforming a predetermined amount of electric energy and for storing it in thermal form, which comprises a driving device (1) according to claim 1 and at least one subassembly capable of transforming electrical energy (2) and of storing it in thermal form.

12. System according to claim 11, wherein the at least one subassembly capable of transforming electrical energy and of storing it in thermal form comprises means for transforming electrical energy in thermal thermodynamic form and ways for transforming electrical energy in thermal form by Joule effect.

13. System according to claim 11, wherein said subassembly capable of transforming electrical energy and storing it in thermal form stores energy in the form of heat relative to room temperature.

14. System according to claim 11, wherein said subassembly capable of transforming electrical energy and of storing it in thermal form stores energy in the form of cold relative to room temperature.

15. System according to claim 11, wherein the at least one subassembly capable of transforming electrical energy and of storing it in thermal form stores energy in a volume of liquid mainly consisting of water.

16. System according to claim 11, wherein the at least one subassembly capable of transforming electrical energy, at least partly, in a volume of solid and/or phase-change material.

17. System according to claim 11, further comprising metering means of energy in thermal form extracted during its use.

18. System according to claim 11, wherein at least a proportion of energy in thermal form extracted during its use is via an electrical current.

19. System according to claim 11, wherein at least a proportion of energy in thermal form extracted during its use is via an air flow conveying it.

20. System according to claim 11, wherein at least a proportion of energy in thermal form extracted during its use is via a flow of liquid conveying it.

21. System according to claim 19, further comprising means for providing an air flow (30) or liquid flow (13) at a temperature different from the temperature at which energy is stored in thermal form.

22. System according to claim 20, wherein the system forms a storage water heater producing hot water for sanitation purposes.

23. System according to claim 20, further comprising a water meter and/or means for measuring the temperature of the water extracted and/or means for measuring the temperature of incoming water.

24. System according to claim 11, wherein the system forms a storage heater and/or cooling apparatus.

25. System according to claim 11, wherein the system is fitted in such a way as to provide at least two distinct types of storage of electrical energy in thermal form, at least one type for recurring storage and at least one type operating a reserve capacity of storage in thermal form for occasional storage.

26. System according to claim 11, further comprising means for contributing to energy input in thermal form which are not connected to the electrical distribution network.

27. Method for operating in an electrical network a plurality of systems capable of transforming a predetermined amount of electric energy and of storing it in thermal form according to claim 11, which comprises the steps of:
Continuous monitoring of the balance between electricity consumption and production in said electrical network by an appropriate supervision and management system;
Transmission by said appropriate supervision and management system to a given plurality of systems, of at least one setpoint for transformation and storage of a predetermined amount of electrical energy, for consuming an accumulated amount of predetermined electric power so as to adjust electricity consumption to production in the case of a given surplus production.

28. Method according to claim 27, which also comprises a step of:
Saving, in at least one information system, of the at least one information related to the transmission by said appropriate supervisory and management system, to a given plurality of systems, of the at least one setpoint for transformation and storage of a predetermined amount of electrical energy.

29. Method according to claim 28, which also comprises a step of:
Correcting within at least one information system, of the at least one figure in connection with the metering of electrical energy consumed in an installation where at least one system is implemented, when the amount of electrical energy consumed by said system has been consumed at least in part while an inappropriate metering index was enabled in the metering means related to said installation.

30. Application of the method according to claim 27 for the management of an electrical network comprising electrical sources for intermittent production.

31. Application of the method according to claim 27 in the framework of a service for acquiring and storing electrical energy produced in surplus.

32. Application of the method according to claim 27 in the framework of a service supplying hot water for sanitation purposes and/or heating and/or cooling and/or electricity.
